(19) United States
(12) Patent Application Publication
(10) Pub. No.: US 2007/0064543 A1
(43) Pub. Date: Mar. 22, 2007

(54) Magnetic field control method, storage apparatus, computer-readable storage medium, read retry method and learning method

(75) Inventor: Masaaki Iwasaki, Kawasaki (JP)

Correspondence Address: Patrick G. Burns, Esq.;GREER, BURNS & CRAIN, LTD., 300 South Wacker Dr., Suite 2500, Chicago, IL, 60606, US

(73) Assignee: FUJITSU LIMITED

(21) Appl. No.: 11/335,101

(22) Filed: Jan. 19, 2006

(30) Foreign Application Priority Data
Sep. 21, 2005 (JP) 2005-274230

(51) Int. Cl. G11B 11/00

(52) U.S. Cl. 369/13.14

(57) ABSTRACT

A magnetic field control method increases or decreases a reproducing magnetic field intensity that is applied to an optical recording medium by a reference offset value in a read retry, and corrects the reference offset value so that the reproducing magnetic field intensity that is actually applied to the optical recording medium becomes an optimum reproducing magnetic field intensity that makes a bit error rate from the optical recording medium less than or equal to a threshold value.

### BACKGROUND OF THE INVENTION

1. Field of the Invention

The present invention generally relates to magnetic field control methods, storage apparatuses, computer-readable storage media, read retry methods and learning methods, and more particularly to a magnetic field control method for controlling a reproducing magnetic field that is applied to an optical recording medium when reproducing information from the optical recording medium, a storage apparatus that uses such a magnetic field control method, a computer-readable storage medium that stores a program for causing a computer to control the magnetic field by such a magnetic field control method, a read retry method and a learning method for reproducing magnetic field control. The present invention also relates to a program for causing a computer to control the magnetic field by such a magnetic field control method.

2. Description of the Related Art

A system call magnetic super resolution (MSR) is known for applying a reproducing magnetic field to an optical recording medium when reproducing information from the optical recording medium by irradiating a light beam on the optical recording medium such as an optical disk. In order to suppress a Bit Error Rate (BER) of the information reproduced from the optical recording medium, that is, to suppress a read error, it is necessary to control the reproducing magnetic field intensity to an appropriate value. When the read error is generated, a read retry is made by increasing or decreasing the reproducing magnetic field intensity by an amount corresponding to a bias offset value, with respect to a reference value that is obtained in advance.

The reproducing magnetic field intensity is controlled by controlling a current flowing through a coil that generates the reproducing magnetic field. A current value of the current applied to the coil that generates the reproducing magnetic field is set depending on the bias offset value. In a case where the bias offset value is fixed, the reproducing magnetic field intensity actually applied to the optical recording medium differs depending on a distance between the coil and the optical recording medium, even when the current flowing through the coil is the same. Accordingly, in the storage apparatus in which the distance between the coil and the optical recording medium is greater than a designed value due to inconsistencies introduced during the production and the like, there is a possibility that the reproducing magnetic field will not reach a target optimum reproducing magnetic field intensity. On the other hand, in the storage apparatus in which the distance between the coil and the optical recording medium is smaller than the designed value, there is a possibility that the reproducing magnetic field will reach an excessively large reproducing magnetic field intensity which exceeds the optimum reproducing magnetic field intensity that minimizes the BER.

The inconsistency in the distance between the coil and the optical recording medium is generated due to the inconsistencies introduced during the production and the like in the storage apparatus in which the coil is fixedly provided, but is generated particularly in the storage apparatus of the type in which the coil moves. In the storage apparatus of the type in which the coil moves, such as an optical disk drive, the coil moves in a radial direction of the optical disk together with an optical system that emits the light beam, and/or moves relative to the optical disk depending on a movement of a cover which opens and closes during loading and unloading of the optical disk with respect to the optical disk drive. Therefore, in the storage apparatus in which the coil moves relative to the optical recording medium, the inconsistency in the distance between the coil and the optical recording medium becomes more conspicuous.

Moreover, due to the inconsistencies in the conditions at the time of the production and the like, each individual optical recording medium itself has a different magnetic field sensitivity. For this reason, even if the reproducing magnetic field intensity that is actually applied to the optical recording media is the same, the BER of the information that is reproduced may differ for each individual optical recording medium.

For example, a Japanese Laid-Open Patent Application No. 2000-182292 proposes a method of controlling the reproducing magnetic field during the read retry. A U.S. Pat. No. 6,687,194 corresponds to this Japanese Laid-Open Patent Application No. 2000-182292.

Conventionally, the bias offset value is set on the precondition that the distance between the coil and the optical recording medium has the constant designed value. But since the current value applied to the coil that generates the reproducing magnetic field is set depending on the bias offset value, the reproducing magnetic field intensity that is actually applied to the optical recording medium becomes different depending on the actual distance between the coil and the optical recording medium. The actual distance between the coil and the optical recording medium can be set within a tolerable range, however, the actual distance cannot be set to the constant designed value due to the inconsistencies introduced during the production and the like. As a result, there was a problem in that the reproducing magnetic field cannot always be controlled to the optimum reproducing magnetic field intensity that minimizes the BER.

In addition, the reproducing magnetic field intensity actually applied to the optical recording medium differs depending on the magnetic field sensitivity of the optical recording medium itself. But conventionally, there was a problem in that the reproducing magnetic field cannot always be controlled to the optimum reproducing magnetic field intensity that minimizes the BER depending on the magnetic field sensitivity of each individual optical recording medium itself.

### SUMMARY OF THE INVENTION

Accordingly, it is a general object of the present invention to provide a novel and useful magnetic field control method, storage apparatus, computer-readable storage medium, read retry method and learning method, in which the problems described above are suppressed.

Another and more specific object of the present invention is to provide a magnetic field control method, a storage apparatus, a computer-readable storage medium, a read retry method and a learning method which can always control a reproducing magnetic field to an optimum magnetic field intensity that minimizes a BER, regardless of a distance between a coil and an optical recording medium, and/or regardless of a magnetic field sensitivity of the optical recording medium itself.

Still another object of the present invention is to provide a magnetic field control method comprising a step increasing or decreasing a reproducing magnetic field intensity that is applied to an optical recording medium by a reference offset value in a read retry; and a correcting step correcting the reference offset value so that the reproducing magnetic field intensity that is actually applied to the optical recording medium becomes an optimum reproducing magnetic field intensity that makes a bit error rate from the optical recording medium less than or equal to a threshold value. According to the magnetic field control method of the present invention, it is possible to always control the reproducing magnetic field to the optimum magnetic field intensity that minimizes the bit error rate (BER), regardless of a distance between a coil and an optical recording medium, and/or regardless of a magnetic field sensitivity of the optical recording medium itself.

A further object of the present invention is to provide a storage apparatus comprising a storage part configured to store a reference offset value by which a reproducing magnetic field intensity that is applied to an optical recording medium is increased or decreased in a read retry; and a correcting part configured to correct the reference offset value so that the reproducing magnetic field intensity that is actually applied to the optical recording medium becomes an optimum reproducing magnetic field intensity that makes a bit error rate from the optical recording medium less than or equal to a threshold value. According to the storage apparatus of the present invention, it is possible to always control the reproducing magnetic field to the optimum magnetic field intensity that minimizes the bit error rate (BER), regardless of a distance between a coil and an optical recording medium, and/or regardless of a magnetic field sensitivity of the optical recording medium itself.

Another object of the present invention is to provide a computer-readable storage medium which stores a program for causing a computer to control a magnetic field, the program comprising a procedure causing the computer to increase or decrease a reproducing magnetic field intensity that is applied to an optical recording medium by a reference offset value in a read retry; and a correcting procedure causing the computer to correct the reference offset value so that the reproducing magnetic field intensity that is actually applied to the optical recording medium becomes an optimum reproducing magnetic field intensity that makes a bit error rate from the optical recording medium less than or equal to a threshold value. According to the computer-readable storage medium of the present invention, it is possible to always control the reproducing magnetic field to the optimum magnetic field intensity that minimizes the bit error rate (BER), regardless of a distance between a coil and an optical recording medium, and/or regardless of a magnetic field sensitivity of the optical recording medium itself.

Still another object of the present invention is to provide a read retry method comprising a step increasing or decreasing a reproducing magnetic field intensity that is applied to an optical recording medium by a reference offset value; and a correcting step correcting the reference offset value so that the reproducing magnetic field intensity that is actually applied to the optical recording medium becomes an optimum reproducing magnetic field intensity that makes a bit error rate from the optical recording medium less than or equal to a threshold value. According to the read retry method of the present invention, it is possible to always control the reproducing magnetic field to the optimum magnetic field intensity that minimizes the bit error rate (BER), regardless of a distance between a coil and an optical recording medium, and/or regardless of a magnetic field sensitivity of the optical recording medium itself.

A further object of the present invention is to provide a learning method for a reproducing magnetic field control that increases or decreases a default value of a reproducing magnetic field intensity that is applied to an optical recording medium when the reproducing magnetic field intensity is increased or decreased by a reference offset value and a read of a read retry is successful, comprising a correcting step correcting the reference offset value so that the reproducing magnetic field intensity that is actually applied to the optical recording medium becomes an optimum reproducing magnetic field intensity that makes a bit error rate from the optical recording medium less than or equal to a threshold value. According to the learning method of the present invention, it is possible to always control the reproducing magnetic field to the optimum magnetic field intensity that minimizes the bit error rate (BER), regardless of a distance between a coil and an optical recording medium, and/or regardless of a magnetic field sensitivity of the optical recording medium itself.

Another object of the present invention is to provide a storage apparatus comprising a part configured to increase or decrease a default value of a reproducing magnetic field intensity that is applied to an optical recording medium when the reproducing magnetic field intensity is increased or decreased by a reference offset value and a read of a read retry is successful; and a correcting step correcting the reference offset value so that the reproducing magnetic field intensity that is actually applied to the optical recording medium becomes an optimum reproducing magnetic field intensity that makes a bit error rate from the optical recording medium less than or equal to a threshold value. According to the storage apparatus of the present invention, it is possible to always control the reproducing magnetic field to the optimum magnetic field intensity that minimizes the bit error rate (BER), regardless of a distance between a coil and an optical recording medium, and/or regardless of a magnetic field sensitivity of the optical recording medium itself.

Still another object of the present invention is to provide a computer-readable storage medium which stores a program for causing a computer to control a reproducing magnetic field that is applied to an optical recording medium, the program comprising a procedure causing the computer to increase or decrease a default value of a reproducing magnetic field intensity that is applied to the optical recording medium when the reproducing magnetic field intensity is increased or decreased by a reference offset value and a read of a read retry is successful; and a correcting procedure causing the computer to correct the reference offset value so that the reproducing magnetic field intensity that is actually applied to the optical recording medium becomes an optimum reproducing magnetic field intensity that makes a bit error rate from the optical recording medium less than or equal to a threshold value. According to the computer-readable storage medium of the present invention, it is possible to always control the reproducing magnetic field to the optimum magnetic field intensity that minimizes the bit error rate (BER), regardless of a distance between a coil and an optical recording medium, and/or regardless of a magnetic field sensitivity of the optical recording medium itself.

Other objects and further features of the present invention will be apparent from the following detailed description when read in conjunction with the accompanying drawings.

### BRIEF DESCRIPTION OF THE DRAWINGS

FIGS. 1A and 1B are diagrams for explaining the operating principle of the present invention;

FIGS. 2A and 2B are diagrams for explaining the operating principle of the present invention;

FIGS. 3A and 3B are diagrams for explaining the operating principle of the present invention;

FIG. 4 is a system block diagram showing an important part of an embodiment of a storage apparatus according to the present invention;

FIG. 5 is a flow chart for explaining a test write;

FIG. 6 is a diagram showing a relationship between a write power and a number of data mismatches;

FIG. 7 is a flow chart for explaining a zone recognition in a test write and a test read;

FIG. 8 is a diagram showing a relationship between zones and areas;

FIG. 9 is a flow chart for explaining the test read;

FIG. 10 is a diagram showing a relationship between a read power and a number of data mismatches;

FIG. 11 is a flow chart for explaining a test read bias control;

FIG. 12 is a diagram showing a relationship between a reproducing magnetic field intensity and a number of data mismatches;

FIG. 13 is a flow chart for explaining a read including retry and learning;

FIG. 14 is a diagram showing kinds of parameters set and amounts changed by a read retry;

FIG. 15 is a top view showing the embodiment of the storage apparatus;

FIG. 16 is a side view showing the embodiment of the storage apparatus; and

FIG. 17 is a bottom view showing the embodiment of the storage apparatus.

### DESCRIPTION OF THE PREFERRED EMBODIMENTS

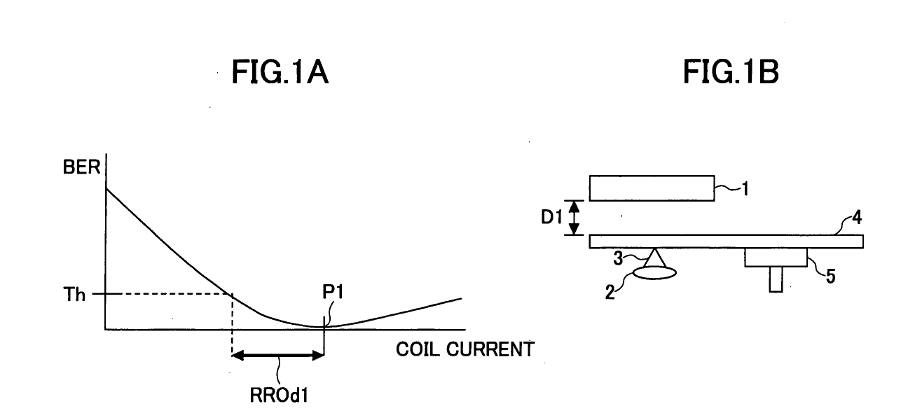

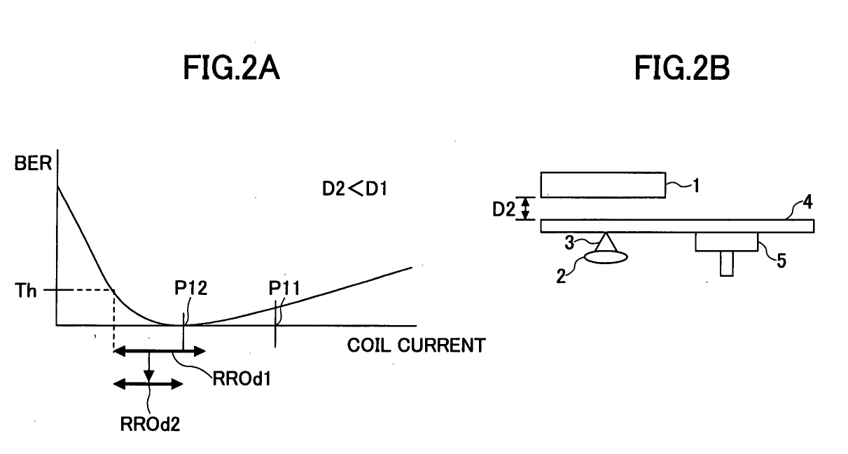

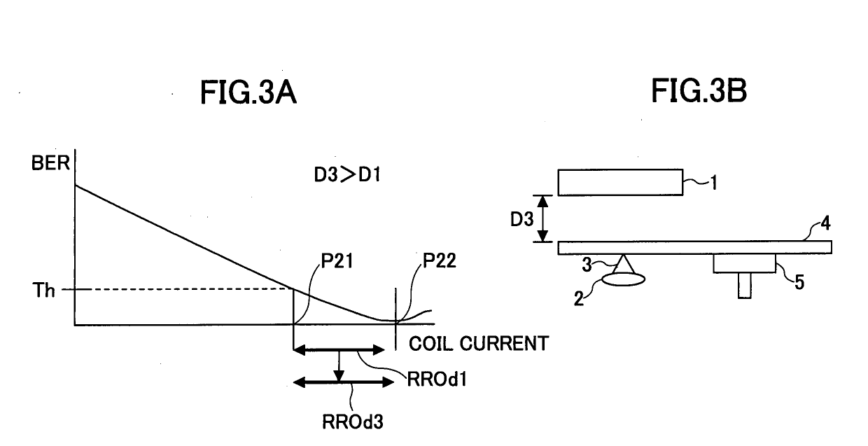

FIGS. 1 through 3 are diagrams for explaining the operating principle of the present invention. FIGS. 1A and 1B show a case where a distance between an optical recording medium and a coil which generates a reproducing magnetic field that is applied to the optical recording medium such as an optical disk at the time of a read is a designed value (ideal value). FIGS. 2A and 2B show a case where the distance between the coil and the optical recording medium is smaller than the designed value. FIGS. 3A and 3B show a case where the distance between the coil and the optical recording medium is larger than the designed value. FIGS. 1A, 2A and 3A respectively show a Bit Error Rate (BER) and a current that is applied to the coil (coil current) in arbitrary units. FIGS. 1B, 2B and 3B respectively show a positional relationship of the coil and the optical recording medium. In FIGS. 1B, 2B and 3B, the coil which generates the reproducing magnetic field is designated by a reference numeral 1, a optical system including a lens is designated by a reference numeral 2, a light beam is designated by a reference numeral 3, the optical recording medium is designated by a reference numeral 4, and a spindle motor which rotates the optical recording medium 4 is designated by a reference numeral 5. When a read error is generated, the current applied to the coil 1 is increased or decreased by a bias offset value, so as to make a read retry by increasing or decreasing the reproducing magnetic field intensity.

In FIG. 1B, the distance between coil 1 and the optical recording medium 4 is a designed value D1. Accordingly, as shown in FIG. 1A, the BER is an optimum value (minimum value) at a point P1, and the reproducing magnetic field intensity of the reproducing magnetic field which is generated by the coil 1 is also an optimum value at this point P1. The bias offset value at this point P1 is 0. In FIG. 1A, RROd1 indicates a reference bias offset value for increasing the current applied to the coil 1 when the BER reaches a threshold value Th and the read retry is made. For example, the reference bias offset value RROd1 is a default value.

In FIG. 2B, the distance between the coil 1 and the optical recording medium 4 is a value D2 that is smaller than the designed value D1. Accordingly, as shown in FIG. 2A, the bias offset value is 0 at a point P11, but the BER is not the optimum value (minimum value) at this point P11. When the BER reaches the threshold value Th and the bias offset value when making the read retry is set to RROd1, there is a possibility of exceeding a point P12 where the BER becomes the optimum value. Hence, in this case, the bias offset value RROd1 is corrected by multiplying thereto a constant coefficient so as to decrease the bias offset value to RROd2, and so that it is possible to control the reproducing magnetic field which is generated by the coil 1 to the optimum reproducing magnetic field intensity.

In FIG. 3B, the distance between the coil 1 and the optical recording medium 4 is a value D3 that is larger than the designed value D1. Accordingly, as shown in FIG. 3A, the bias offset value at a point P21 is 0, but the BER is not the optimum value (minimum value) at this point P21. When the BER reaches the threshold value Th and the bias offset value when making the read retry is set to RROd1, there is a possibility of not reaching a point P22 where the BER becomes the optimum value. Hence, in this case, the bias offset value RROd1 is corrected by multiplying thereto a constant coefficient so as to increase the bias offset value to RROd3, and so that it is possible to control the reproducing magnetic field which is generated by the coil 1 to the optimum reproducing magnetic field intensity.

Therefore, during the read operation with respect to the optical recording medium 4 which requires the reproducing magnetic field to be applied thereto at the time of the read, such as an MSR medium, when the read retry is made by increasing or decreasing the reproducing magnetic field intensity by an amount corresponding to the reference bias offset value, the reference bias offset value that is increased or decreased is corrected based on a result of a test read bias control. In the test read bias control, a test pattern is actually recorded on and reproduced from the optical recording medium 4, and the reproducing magnetic field intensity that makes the BER less than or equal to the threshold value is obtained. The coefficient (correction value) which is to be multiplied to the reference bias offset value RROd1 in order to generate, by the coil 1, the reproducing magnetic field intensity that is obtained, is calculated, and the calculated coefficient is fed back to a circuit system that generates the current which drives the coil 1.

The amount of the reproducing magnetic field intensity that is increased or decreased by the read retry is not simply controlled by the current value that is applied to the coil 1, but is controlled so that the reproducing magnetic field intensity that is applied to the optical recording medium 4 becomes constant regardless of the actual distance between the coil 1 and the optical recording medium 4. Since it is difficult to measure the actual distance between the coil 1 and the optical recording medium 4 within the storage apparatus, the reference bias offset value that is increased or decreased in the read retry is corrected based on the result of the test read bias control.

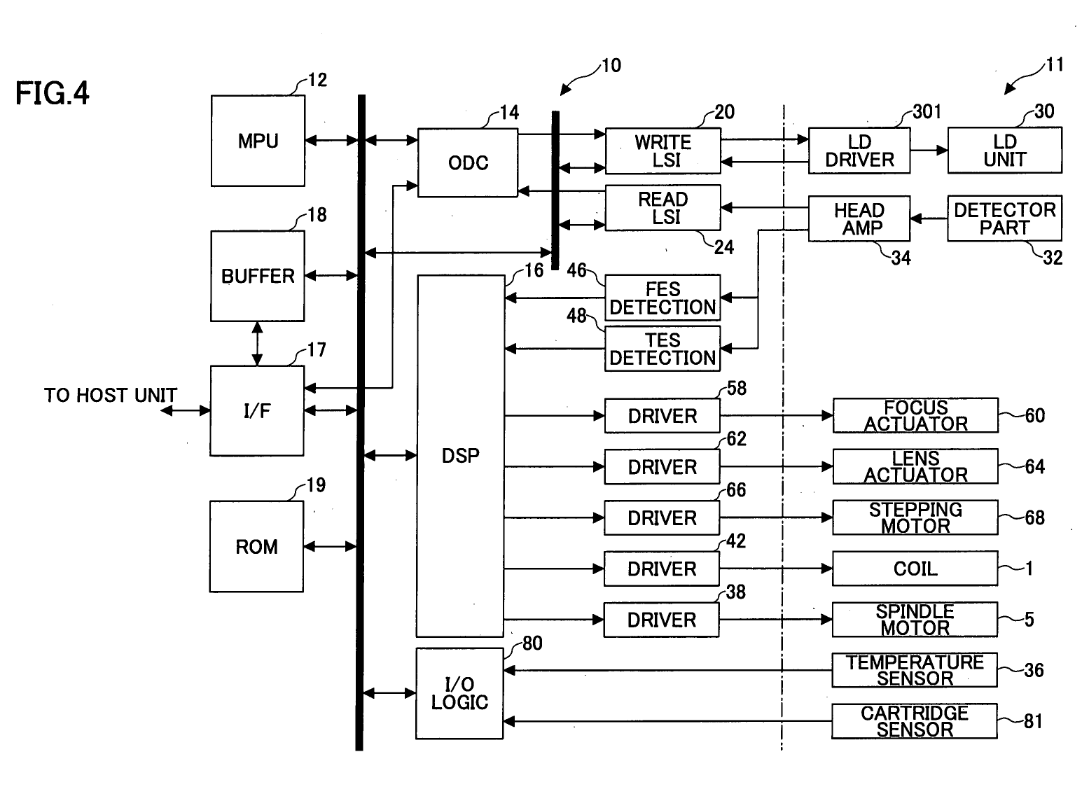

A description will be given of an embodiment of a storage apparatus according to the present invention, by referring to FIG. 4. FIG. 4 is a system block diagram showing an important part of this embodiment of the storage apparatus according to the present invention. In this embodiment of the storage apparatus, the present invention is applied to an optical disk drive. In addition, this embodiment of the storage apparatus employs an embodiment of a magnetic field control method according to the present invention.

As shown in FIG. 4, an optical disk drive generally includes a control unit 10 and an enclosure 11. The control unit 10 includes an MPU 12 for generally controlling the entire optical disk drive, an interface 17 for exchanging commands and data between a host unit (not shown) and the optical disk drive, an optical disk controller (ODC) 14 for carrying out processes necessary to read data from and write data to an optical disk (not shown), a digital signal processor (DSP) 16, a buffer 18, a ROM 19 and an input and output (I/O) logic circuit 80. The buffer 18 and the ROM 19 are shared by the MPU 12, the ODC 14 and the interface 17, and includes a dynamic random access memory (DRAM), a nonvolatile memory for storing control programs and flag information, and the like.

The ODC 14 includes a formatter (not shown) and an error correction code (ECC) processing part (not shown). At the time of a write access, the formatter segments NRZ write data into sector units of the optical disk to generate a recording format, and the ECC processing part generates and adds an ECC in sector write data units, and generates and adds a cyclic redundancy check (CRC) code if necessary. In addition, the ECC processing part converts the sector data having the encoded ECC into a 1-7 run length limited (RLL) code, for example. At the time of a read access, an inverse conversion of the 1-7 RLL is made with respect to the sector data, and the ECC processing part carries out a CRC and thereafter carries out an error detection and error correction by the ECC. Furthermore, the formatter connects the data in the sector units and transfers a stream of read data to the host unit.

A write large scale integrated circuit (LSI) 20 is provided with respect to the ODC 14. The write LSI 20 includes a write modulator part (not shown) and a laser diode control circuit (not shown). A control output of the laser diode control circuit is supplied to a laser diode unit 30 via a laser diode driver 301 that is provided in an optical unit within the enclosure 11. The write modulator part converts a data format of the write data into a data format for the pit position modulation (PPM) recording (or mark recording) or the pulse width modulation (PWM) recording (or edge recording).

This embodiment employs the PWM recording which records the data in correspondence with the existence and non-existence of mark edges on the optical disk, with respect to the optical disk to which the data is recorded and from which the data is reproduced using the laser diode unit 30, that is, with respect to a rewritable magneto-optical (MO) cartridge medium. The recording format on the optical disk is the 1.3 GB format using the magnetic super resolution (MSR), and the zone CAV (ZCAV) system is employed. When the optical disk is loaded into the optical disk drive, an identification (ID) part on the optical disk is read first, and the MPU 12 recognizes the type (storage capacity and the like) of the optical disk from the intervals of the pits in the ID part and notifies the recognized type of optical disk to the ODC 14.

A read LSI 24 is provided as a read system with respect to the ODC 14. The read LSI 24 includes a read demodulator part (not shown) and a frequency synthesizer (not shown). Light reception signals from a detector part 32 provided within the enclosure 11, corresponding to the light beam which is emitted from the laser diode unit 30 and is returned via the optical disk, are input to the read LSI 24 via a head amplifier 34, as an ID signal and a MO signal. The read demodulator part of the read LSI 24 is provided with circuit functions such as an automatic gain control (AGC) circuit, a filter and a sector mark detection circuit, and generates a read clock and read data from the input ID signal and MO signal, so as to demodulate the PWM data back into the original NRZ data. In addition, since the ZCAV system is employed, the MPU 12 controls a setting of a frequency dividing ratio of the frequency synthesizer within the read LSI 24, so as to generate a clock frequency in correspondence with the zone.

The read data demodulated in the read LSI 24 is supplied to the read system of the ODC 14, and after being subjected to the inverse conversion of the 1-7 RLL, the read data is subjected to the CRC and ECC process by the encoding function of the ECC processing part, and is restored to the NRZ sector data. Next, the formatter connects the NRZ sector data and converts the NRZ sector data into the stream of NRZ read data which is transferred to the host unit via the buffer 18 and the interface 17.

A detection signal from a temperature sensor 36 within the enclosure 11 is supplied to the MPU 12 via the I/O logic circuit 80 and/or the DSP 16. Based on the environmental temperature within the optical disk drive detected by the temperature sensor 36, the MPU 12 controls the light emission power of the laser diode control circuit to an optimum value for each of the read, write and erase.

The MPU 12 controls a spindle motor 5 within the enclosure 11 via the DSP 16 and a driver 38. In addition, the MPU 12 controls the coil 1 within the enclosure 11 via the DSP 16 and a driver 42. The coil 1 is arranged on one side of the loaded optical disk within the optical disk drive, opposite to the side irradiated with the light beam. The coil 1 applies an external magnetic field (write magnetic field and an erase magnetic field) to the optical disk at the time of the recording (write) and at the time of the erasure. In the case of the optical disk having the 1.3 GB format and employing the MSR, the coil 1 also applies an external magnetic field (reproducing magnetic field) to the optical disk at the time of the reproduction (read).

The DSP 16 has a servo function for positioning the light beam from the laser diode unit 30 with respect to the optical disk, and functions as a seek control part for seeking a target track and an on-track control part for tracking the target track. The seek control and the on-track control can be carried out simultaneously in parallel with the write access or the read access by the MPU 12 with respect to a host command.

In order to realize the servo function of the DSP 16, a focus error signal (FES) detector is provided in the detector part 32 to receive the return light beam from the optical disk. An FES detection circuit 46 inputs to the DSP 16 a signal that is generated from a detection output of the FES detector. A tracking error signal (TES) detector is also provided in the detector part 32 to receive the return light beam from the optical disk. A TES detection circuit 48 inputs to the DSP 16 a signal that is generated from a detection output of the TES detector.

The DSP 16 controls and drives a focus actuator 60, a lens actuator 64 and a stepping motor (or a voice coil motor (VCM)) 68 via drivers 58, 62 and 66, so as to control the position of the beam spot on the optical disk.

A cartridge sensor 81 within the enclosure 11 detects the loading and unloading of the MO cartridge medium, that is, the optical disk, with respect to the optical disk drive, and outputs a detection result to the I/O logic circuit 80.

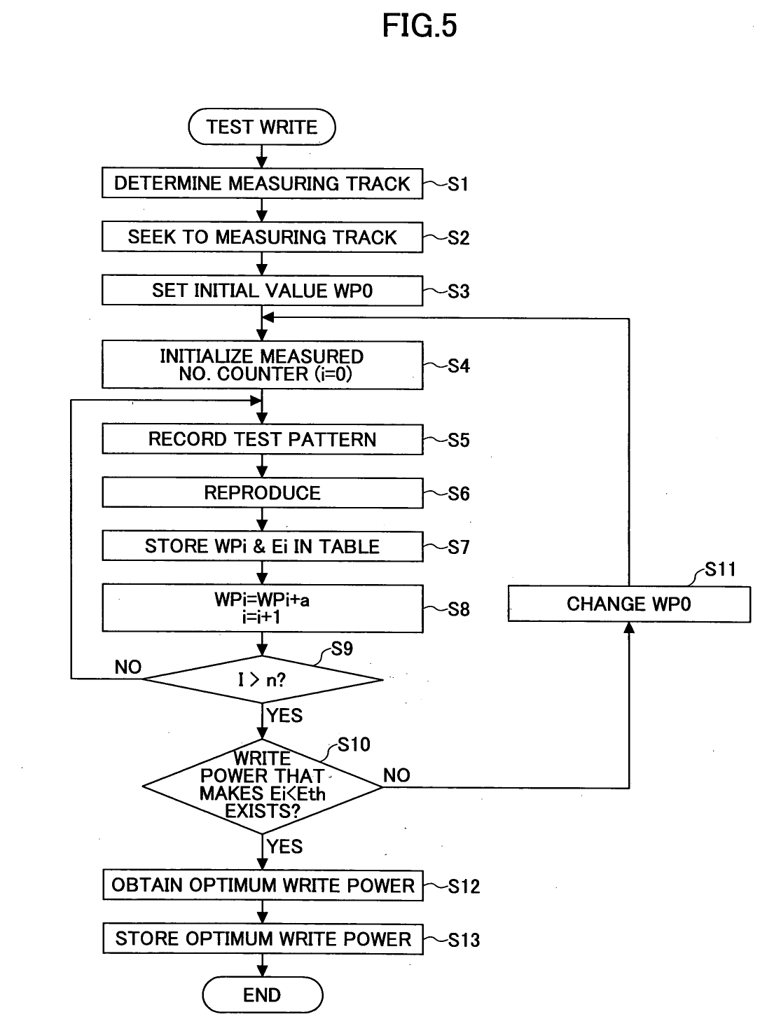

FIG. 5 is a flow chart for explaining a test write that is carried out under the control of the MPU 12. When a write command is issued from the host unit, a test write process for obtaining an optimum laser power for the write is carried out, prior to the actual write operation. A step S1 determines a measuring track on the optical recording medium 4 where the test write is to be made, from a write position included in the command from the host unit, and a step S2 carries out a seek operation to the measuring track. A step S3 sets a write power of the light beam 3 to an initial value WP0, and a step S4 initializes a value of a measured number counter within the MPU 12 to i=0, for example. A step S5 records (writes) on the measuring track a test pattern that is set in advance, and a step S6 reproduces (reads) the test pattern from the measuring track. A step S7 stores in a read confirmation table within the buffer 18, for example, a write power WPi and a number Ei of data mismatches indicating a number of times the data do not match between the test pattern that is actually read and the test pattern that is set in advance. A step S8 increases the write power WPi to WPi=WPi+a, where a is a positive or negative value, and counts up the value of the measured number counter to i=i+1. A step S9 decides whether i>n, where n is a predetermined number, and the process returns to the step S5 if the decision result in the step S9 is NO.

On the other hand, if the decision result in the step S9 is YES, a step S10 decides whether or not a write power that results in Ei<Eth is stored in the read confirmation table described above, where Eth denotes a threshold value of the number Ei of data mismatches. If the decision result in the step S10 is NO, a step S11 changes the write power WP0, and the process returns to the step S4.

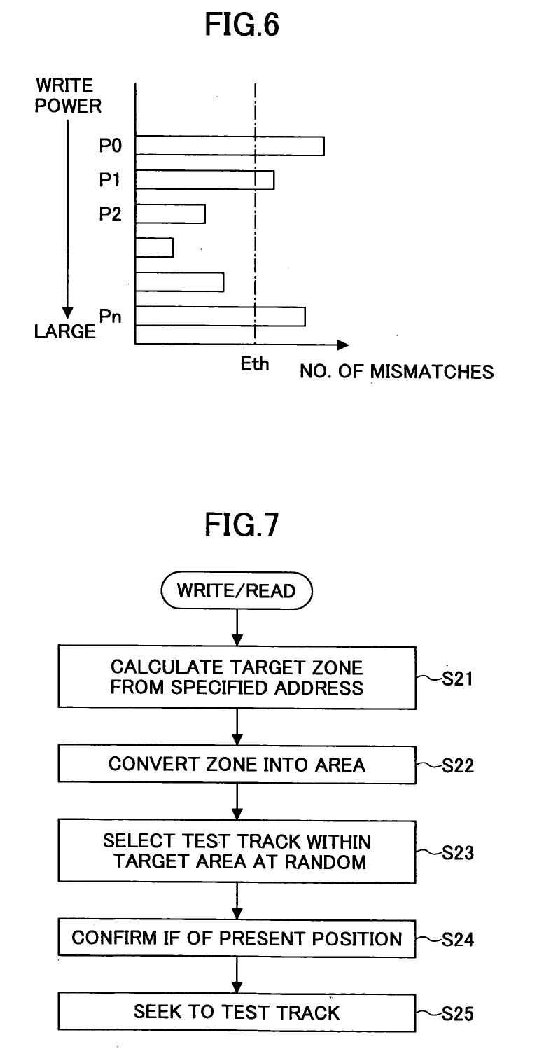

FIG. 6 is a diagram showing a relationship between the write power and the number of data mismatches. As shown in FIG. 6, as the write power (arbitrary units) increases from WP0 to WPn, the number E of data mismatches (arbitrary units) increases and decreases.

In FIG. 5, if the decision result in the step S10 is YES, a step S12 obtains the optimum write power from the number of data mismatches in the read confirmation table described above. A step S13 stores the optimum write power in the buffer 18, for example, and the process ends. Hence, the optimum write power, that is, the default value of the write power with respect to the loaded optical disk, is obtained.

FIG. 7 is a flow chart for explaining a zone recognition in a test write, and in a test read and a test read bias which will be described later. When a write command or a read command is issued from the host unit, a step S21 calculates a target zone based on an address that is specified by the command.

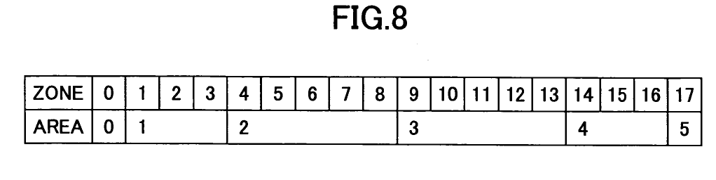

FIG. 8 is a diagram showing a relationship between zones and areas on the optical recording medium 4. In the case where the optical recording medium 4 is an optical disk, the zones and the areas that are arranged in ring shapes in a radial direction of the optical disk have the relationship shown in FIG. 8, for example. In this example, the optical disk is divided into 18 zones, and zones having relatively similar characteristics are gathered into 6 areas.

A step S22 shown in FIG. 7 converts the target zone to which the specified address belongs into a corresponding target area, based on the relationship shown in FIG. 8. A step S23 selects a test track within the target area at random, and a step S24 confirms the ID of the present write or read position. A step S25 carries out a seek operation to the test track.

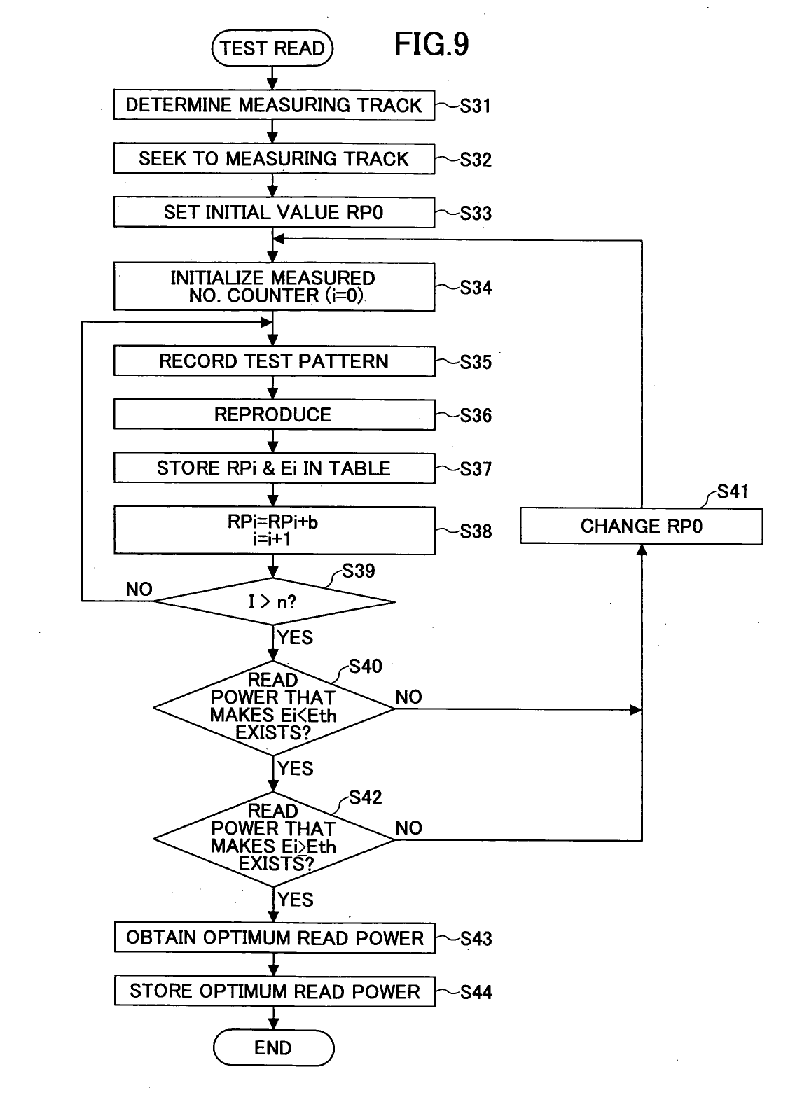

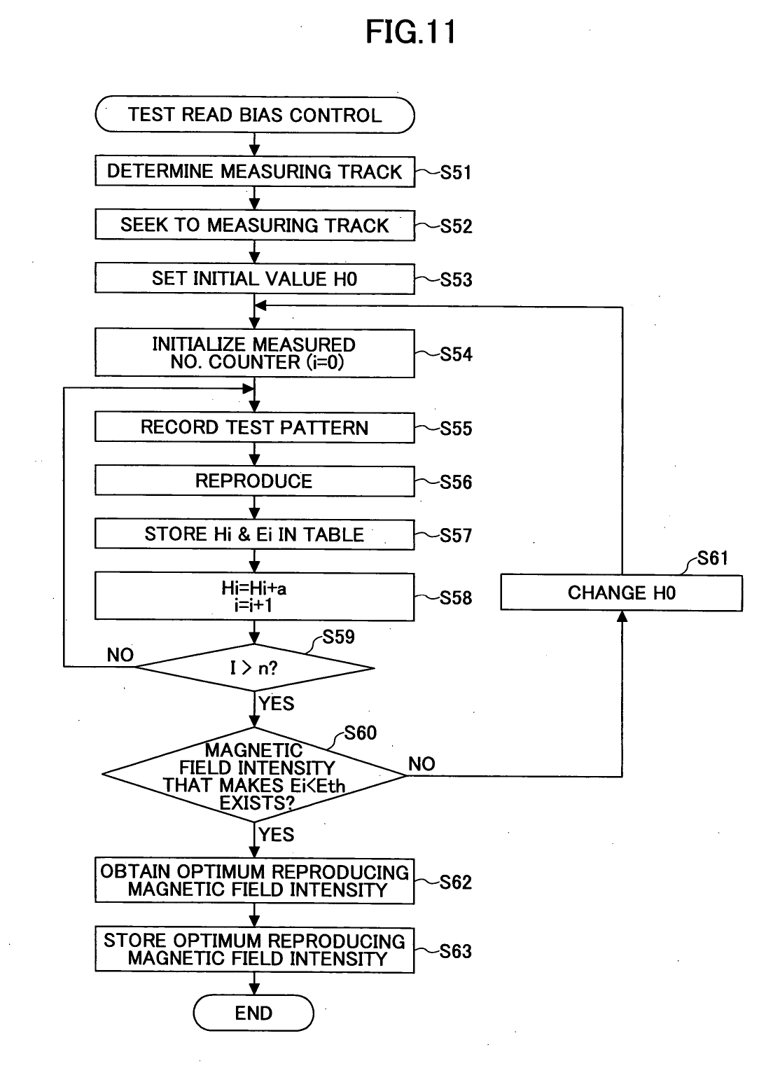

FIG. 9 is a flow chart for explaining the test read that is carried out under the control of the MPU 12. FIG. 11 is a flow chart for explaining the test read bias control that is carried out under the control of the MPU 12. When the read command is issued from the host unit, the test read process for obtaining the optimum laser power for the read and the test read bias for obtaining the optimum reproducing magnetic field are carried out prior to the actual read operation.

In the test read shown in FIG. 9, a step S31 determines a measuring track on the optical recording medium 4 where the test read is to be carried out, and a step S32 carries out a seek operation to the measuring track. A step S33 sets an initial value RP0 of the read power of the light beam 3, and a step S34 initializes the value of a measured number counter within the MPU 12 to i=0, for example. A step S35 records (writes) a test pattern that is set in advance on the measuring track, and a step S36 reproduces (reads) the test pattern from the measuring track. A step S37 stores the test pattern that is actually read, and the number Ei of data mismatches between the test pattern that is actually read and the test pattern that is set in advance, in the read confirmation table within the buffer 18, for example. A step S38 increases a read power RPi to RPi=RPi+b, where b is a positive or negative value, and counts up the value of the measured number counter to i=i+1. A step S39 decides whether or not i>n, where n is a predetermined number, and the process returns to the step S35 if the decision result in the step S39 is NO. On the other hand, if the decision result in the step S39 is YES, a step S40 decides whether or not a read power that results in Ei<Eth is stored in the read confirmation table described above, where Eth denotes a threshold value of the number Ei of data mismatches. If the decision result in the step S40 is NO, a step S41 changes the read power RP0, and the process returns to the step S34.

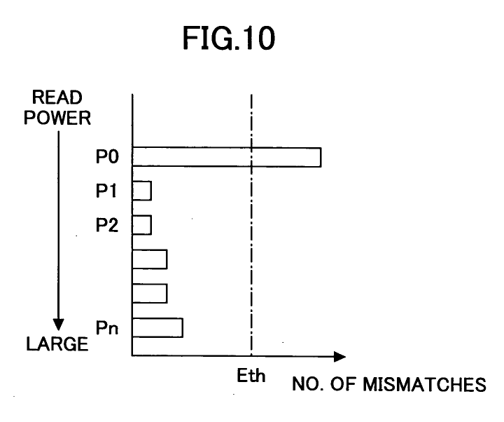

FIG. 10 is a diagram showing a relationship between the read power and the number of data mismatches. As shown in FIG. 10, as the read power (arbitrary unit) increases from RP0 to RPn, the number E of data mismatches (arbitrary unit) increases and decreases.

In FIG. 9, if the decision result in the step S40 is YES, a step S42 decides whether or not a read power that results in Ei≧Eth is stored in the read confirmation table described above. The process returns to the step S41 if the decision result in the step S42 is NO. On the other hand, if the decision result in the step S42 is YES, a step S43 obtain the optimum read power from the number of data mismatches in the read confirmation table. A step S44 stores the optimum read power in the buffer 18, for example, and the process ends. Hence, the optimum read power, that is, the default value of the read power with respect to the loaded optical disk, is obtained.

In the test read bias shown in FIG. 11, a step S51 determines a measuring track on the optical recording medium 4 where the test read bias control is to be carried out, and a step S52 carries out a seek operation to the measuring track. A step S53 sets an initial value HO of the reproducing magnetic field intensity to be applied to the optical recording medium 4, and a step S54 initializes the value of a measured number counter within the MPU 12 to i=0, for example. A step S55 records (writes) a test pattern that is set in advance on the measuring track, and a step S56 reproduces (reads) the test pattern from the measuring track. A step S57 stores a reproducing magnetic field intensity Hi, and the number Ei of data mismatches between the test pattern that is actually read and the test pattern that is set in advance, in the read confirmation table within the buffer 18, for example. A step S58 increases the reproducing magnetic field intensity Hi to Hi=Hi+c, where c is a positive or negative value, and counts up the value of the measured number counter to i=i+1. A step S59 decides whether or not i>n, where n is a predetermined number, and the process returns to the step S55 if the decision result in the step S59 is NO.

On the other hand, if the decision result in the step S59 is YES, a step S60 decides whether or not a reproducing magnetic field intensity that results in Ei<Eth is stored in the read confirmation table described above, where Eth denotes a threshold value of the number Ei of data mismatches. If the decision result in the step S60 is NO, a step S61 changes the reproducing magnetic field intensity HO, and the process returns to the step S54.

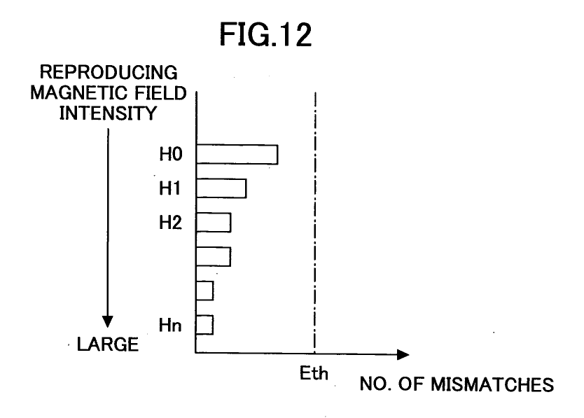

FIG. 12 is a diagram showing a relationship between the reproducing magnetic field intensity and the number of data mismatches. As shown in FIG. 12, as the reproducing magnetic field intensity (arbitrary unit) increases from HO to Hn, the number E of data mismatches (arbitrary unit) decreases.

In FIG. 11, if the decision result in the step S60 is YES, a step S62 obtains the optimum reproducing magnetic field intensity from the number of data mismatches in the read confirmation table. Hence, the optimum reproducing magnetic field intensity, that is, the default value of the magnetic field intensity with respect to the loaded optical disk, is obtained.

In the step S8 shown in FIG. 5, the step S38 shown in FIG. 9 and the step S58 shown in FIG. 11, the positive or negative values a, b and c are added. However, it is of course possible to multiply an arbitrary coefficient instead.

Next, a description will be given of the timings of the test write and the test read, and the test read bias.

In the case where the optical recording medium 4 is the optical disk and the optical disk is loaded into the optical disk drive, the test write and the test read are made with respect to the outermost peripheral zone and the innermost peripheral zone of the optical disk, for example. In the case of the normal optical disk, the MAP information of the optical disk is written in the outermost peripheral zone and the innermost peripheral zone, and the test write and the test read are made with respect to the outermost peripheral zone and the innermost peripheral zone of the optical disk in order to reproduce this MAP information. In addition, the test write is carried out to determine the write power with which the write is made when carrying out the test read.

After the optical disk is loaded into the optical disk drive, during a predetermined time of 3 minutes, for example, the results obtained by the test write and the test read are valid for only a short valid time of 30 seconds, for example. When the write command or the read command is issued from the host unit after the valid time elapses, the test write and the test read, and the test read bias are carried out again.

In addition, after the optical disk is loaded into the optical disk drive, after a predetermined time of 3 minutes, for example, it is possible to carry out the test write and the test read, and the test read bias may be carried out based on the temperature change. In this case, the when a difference between the temperature within the optical disk drive previously detected by the temperature sensor 36 and the temperature within the optical disk drive presently detected by the temperature sensor 36 reaches a predetermined value of 3° C., for example, the test write and the test read, and the test read bias are carried out again.

The time and the temperature difference described above may be provided independently for the test write, the test read and the test read bias. In addition, the test read and the test read bias do not necessarily have to be carried out simultaneously in response to one read command, for example.

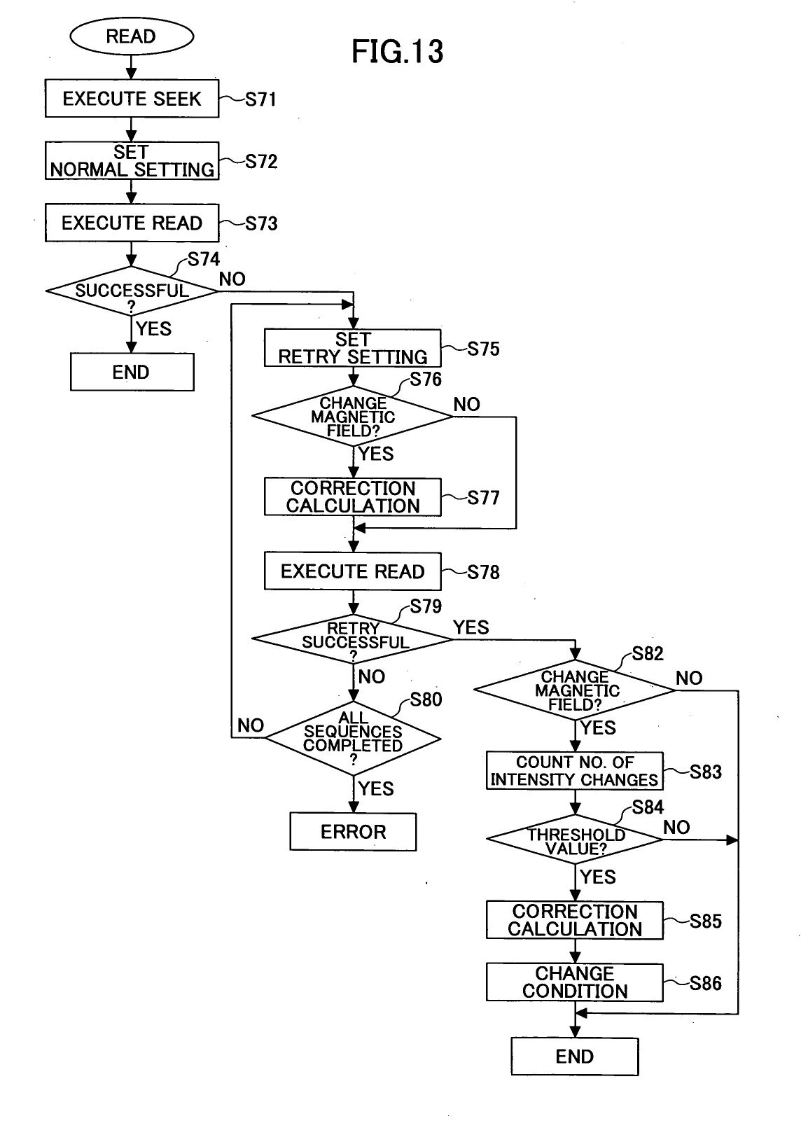

FIG. 13 is a flow chart for explaining a read, including retry and learning, carried out under the control of the MPU 12. When a read command is issued from the host unit, a step S71 starts a seek operation to the track of the read address, and a step S72 carries out a normal setting to set various parameters that are used at the time of the read to respective default values. By this normal setting, the default values of the read power, the write power and the optimum reproducing magnetic field intensity that are obtained in the above described manner are set. In addition, the default value of the frequency dividing ratio or the time constant of the frequency synthesizer within the read LSI 24 and the like are set by this normal setting. A step S73 carries out a read using the various default values that are set. A step S74 decides whether or not the read is successful, and the process ends if the decision result in the step S74 is YES.

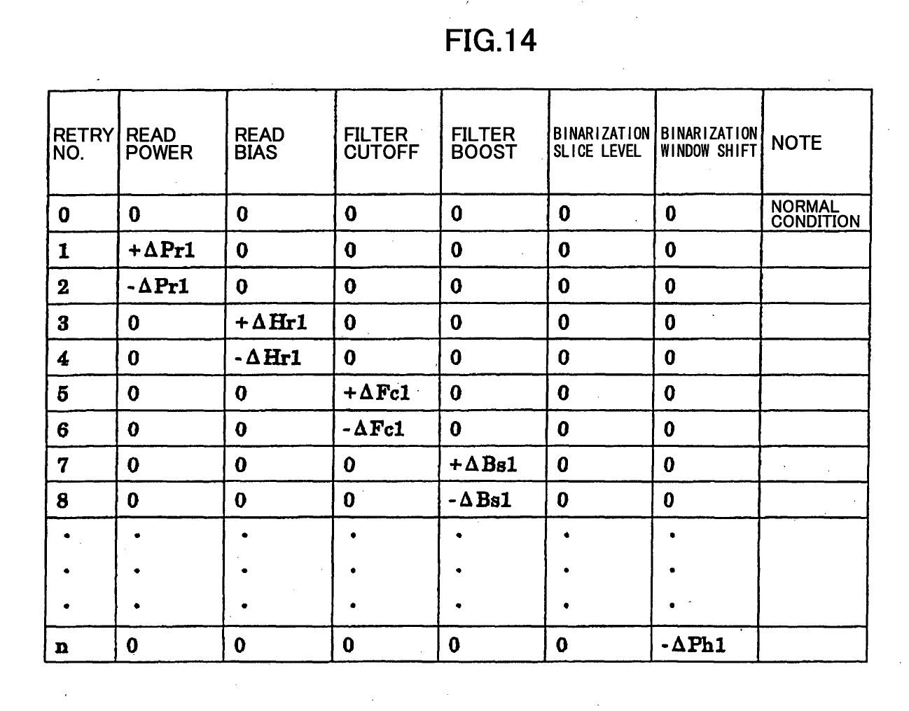

On the other hand, if the decision result in the step S74 is NO, a step S75 carries out a retry setting. FIG. 14 is a diagram showing the kinds of parameters set and the amounts changed by the read retry. Parameters that are changed, a reference offset value (reference changing amount) of the parameters to be changed, a correction value of the reference offset value, an increasing or decreasing width of the correction value and the like are set with respect to each retry number by the retry setting. FIG. 14 shows the read power, the read bias, the filter cutoff, the filter boost, the binarization slice level and the binarization window shift as examples of the parameters of the reproducing system. In FIG. 14, the retry number “0” indicates the normal read setting (normal condition). In addition, the settings all show the offset value with respect to the default value. In the example shown in FIG. 14, only one parameter is changed in one retry, but it is of course possible to simultaneously change a plurality of parameters.

A step S76 decides whether or not the retry setting includes a change (or correction) of the reference offset value of the reproducing magnetic field intensity. If the decision result in the step S76 is YES, a step S77 obtains a correction offset value from a value corresponding to the difference between the result obtained by the test read bias and the result of the test read bias obtained in advance in the ideal state by multiplying a correction value, with respect to a reference offset value RPOd1 which is set in advance for increasing or decreasing the default value for the read retry, and carries out a correction calculation to increase or decrease the correction offset value and to store in the buffer 18 the current value to be supplied to the coil 1, and increases or decreases the current value supplied to the coil 1 by an amount corresponding to the correction offset value.

The result of the test read bias obtained in the ideal state refers to the result obtained by the test read bias carried out a nominal conditions of the parameters. For example, the table of the current to be supplied to the coil 1 is set so that the offset value obtained by the test read bias becomes 0 when the distance (A of a mechanical design value A±α) between the coil 1 and the optical recording medium 4, the sensitivity of the optical recording medium 4, the circuit characteristic and the like all have the nominal values (that is, all are in the ideal states) from the design point of view.

If the decision result in the step S76 is NO or, after the step S77, a step S78 decides whether or not the read retry using the parameters set by the retry setting was successful. If the decision result in the step S78 is NO, a step S80 decides whether or not all changing sequences and retry numbers of the parameters that are set by the retry setting and are to be changed have been completed. If the decision result in the step S80 is NO, the process returns to the step S75, and if the decision result in the step S76 is YES, the step S77 carries out the correction calculation using the correction value that is increased or decreased by the increasing or decreasing width of the correction value set by the retry setting. If the decision result in the step S80 is YES, an error notification is made with respect to the host unit.

If the decision result in the step S79 is YES, a step S82 decides whether or not the successful read retry is caused by the change in the reproducing magnetic field intensity. For example, if the decision result in the step S79 is NO even when the read power is changed depending on the retry setting but the decision result in the step S79 becomes YES if the reproducing magnetic field intensity is changed depending on the retry setting, it may be seen that the successful read retry is caused by the changed in the reproducing magnetic field intensity. The process ends if the decision result in the step S82 is NO.

If the decision result in the step S82 is YES, a step S83 counts the number of times the reproducing magnetic field intensity is changed depending on the retry setting, in a counter within the MPU 12, for example. A step S84 decides whether or not the value of the counter has reached a learning threshold value, and the process ends if the decision result in the step S84 is NO. If the decision result in the step S84 is YES, a step S85 obtains a correction offset value from a value corresponding to the difference between the result obtained by the test read bias and the result of the test read bias obtained in advance in the ideal state by multiplying a correction value, with respect to an offset value which is determined in advance for correcting the default value and is added with respect to the optimum magnetic field intensity that is obtained by the test read bias. A step S86 carries out a learning in which the correction offset value is added to the default value to update the default value, and the process ends.

The reference offset value for changing the reproducing magnetic field intensity, that is set by the retry setting in the step S75, may be obtained in advance by carrying out a process similar to that carried out by the steps S75 through S80, using a standard optical disk having a standard magnetic field sensitivity and a standard optical disk drive in which the distance between the coil 1 and the loaded standard optical disk is set to a standard distance, and stored in the buffer 18 or the ROM 19 when forwarding each optical disk drive. The reference reproducing magnetic field intensity may also be stored in the buffer 18 or the ROM 19 when forwarding each optical disk drive, by carrying out a process similar to that of the test read bias control shown in FIG. 11 using the standard optical disk drive and the standard optical disk.

Accordingly, when the read retry is generated, the step S77 obtains the offset value with respect to the reference optimum reproducing magnetic field intensity, by comparing the reference optimum reproducing magnetic field intensity and the optimum reproducing magnetic field intensity which is the default value. In addition, the step S77 adds or multiplies a coefficient that is set in advance to a difference between the offset value and the reference offset value so as to obtain the correction value, that is, the correction value for correcting the reference offset value to the offset value with respect to the actual optimum reproducing magnetic field intensity. When the value of the counter exceeds the threshold value and the default condition of the learning needs to be changed in the step S83, it is also possible to similarly obtain the correction value for correcting the offset value with respect to the actual optimum reproducing magnetic field intensity.

The correction offset values and the learned values stored in the buffer 18 and the like within the optical disk drive are reset when the optical disk is unloaded from the optical disk drive. This is because, the correction offset values and the learned values change depending on the congeniality between the optical disk drive and each optical disk that is loaded into this optical disk drive.

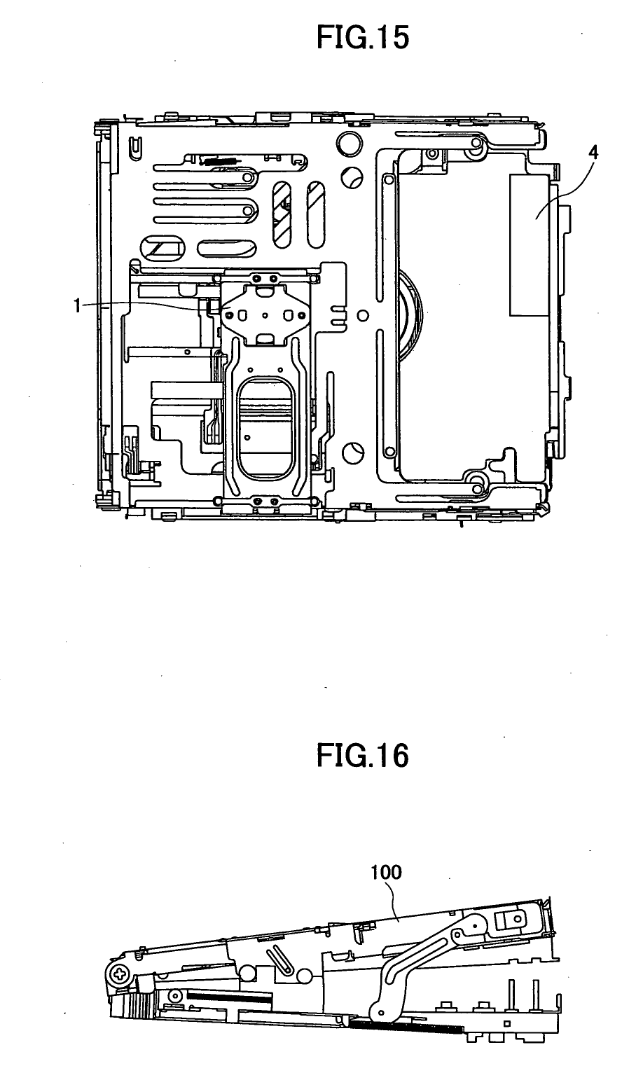

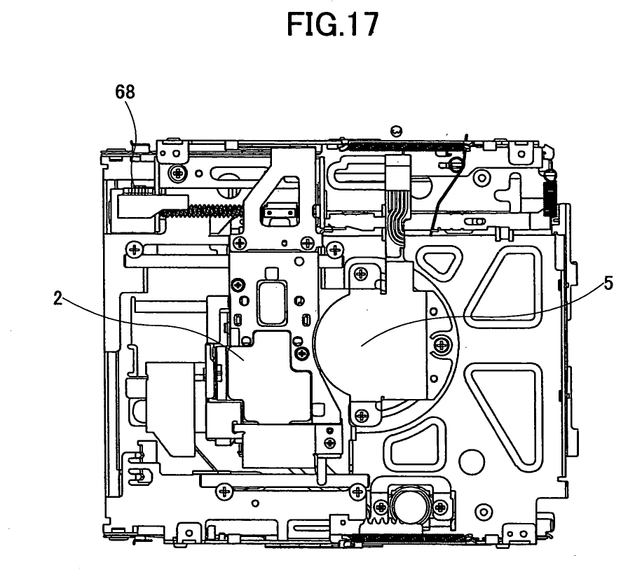

FIG. 15 is a top view showing the embodiment of the storage apparatus. FIG. 16 is a side view showing the embodiment of the storage apparatus. FIG. 17 is a bottom view showing the embodiment of the storage apparatus. FIG. 16 shows a state where a cover 100 is opened and the optical disk 4 is loadable into the optical disk drive or, the optical disk 4 is unloadable from the optical disk drive.

The inconsistency in the distance between the coil and the optical recording medium is generated due to the inconsistencies introduced during the production and the like in the storage apparatus in which the coil is fixedly provided, but is generated particularly in the storage apparatus of the type in which the coil moves.

The storage apparatus shown in FIGS. 15 through 17 is of the type in which the coil 1 moves. The coil 1 moves in the radial direction of the optical disk 4 together with the optical system 2 that emits the light beam 3, and/or moves relative to the optical disk 4 depending on a movement of the cover 100 which opens and closes during loading and unloading of the optical disk 4 with respect to the optical disk drive. In the optical disk drive in which the coil 1 moves relative to the optical disk 4, the inconsistency in the distance between the coil 1 and the optical disk 4 becomes more conspicuous.

Moreover, due to the inconsistencies in the conditions at the time of the production and the like, each individual optical disk 4 itself has a different magnetic field sensitivity. For this reason, even if the reproducing magnetic field intensity that is actually applied to the optical disks 4 is the same, the BER of the information that is reproduced may differ for each individual optical disk 4.

But according to this embodiment, it is possible to correct the offset value of the reproducing magnetic field intensity ay the time of the read retry to an optimum value, regardless of the inconsistencies introduced during the production process of the optical disk drive. In addition, in the optical disk drive in which the distance between the coil 1 and the optical disk 4 is short, it is possible to reduce the current that is supplied to the coil 1 and reduce the power consumption. Furthermore, by carrying out the test read bias control for each area that is provided in the radial direction of the optical disk 4 as described above in conjunction with FIG. 8, it is possible to apply a stable reproducing magnetic field to the optical disk 4 even when the coil 1 and the optical disk 4 are not perfectly parallel to each other, and even when the optical disk 4 is not flat in the radial direction and has a shape that is curved in the radial direction.

A computer-readable storage medium according to the present invention stores a program for causing a computer to control the reproducing magnetic field in the manner described above. The computer-readable storage medium may be formed by any recording media capable of storing the computer in a computer-readable manner, such as magnetic recording media, optical recording media, magneto-optical recording media and semiconductor memory devices.

This application claims the benefit of a Japanese Patent Application No. 2005-274230 filed Sep. 21, 2005, in the Japanese Patent Office, the disclosure of which is hereby incorporated by reference.

Further, the present invention is not limited to these embodiments, but various variations and modifications may be made without departing from the scope of the present invention.

What is claimed is:

1. A magnetic field control method comprising:
a step increasing or decreasing a reproducing magnetic field intensity that is applied to an optical recording medium by a reference offset value in a read retry; and
a correcting step correcting the reference offset value so that the reproducing magnetic field intensity that is actually applied to the optical recording medium becomes an optimum reproducing magnetic field intensity that makes a bit error rate from the optical recording medium less than or equal to a threshold value.

2. The magnetic field control method as claimed in claim 1, wherein the correcting step obtains the correction value from a value corresponding to a difference between a result of a test read bias carried out prior to an actual read operation to obtain the optimum reproducing magnetic field intensity and a result of a test read bias carried out in an ideal state.

3. The magnetic field control method as claimed in claim 2, further comprising:
a storing step storing the result of the test read bias carried out prior to the actual read operation.

4. The magnetic field control method as claimed in claim 1, further comprising:
a learning step updating the correction value to a new correction value when a number of times the reference offset value is corrected reaches a learning threshold value by a time the reproducing magnetic field intensity actually applied to the optical recording medium reaches the optimum reproducing magnetic field intensity.

5. The magnetic field control method as claimed in claim 1, wherein the correcting step corrects the reference offset value for each area on the optical recording medium.

6. A storage apparatus comprising:
a storage part configured to store a reference offset value by which a reproducing magnetic field intensity that is applied to an optical recording medium is increased or decreased in a read retry; and
a correcting part configured to correct the reference offset value so that the reproducing magnetic field intensity that is actually applied to the optical recording medium becomes an optimum reproducing magnetic field intensity that makes a bit error rate from the optical recording medium less than or equal to a threshold value.

7. The storage apparatus as claimed in claim 6, wherein the correcting part obtains the correction value from a value corresponding to a difference between a result of a test read bias carried out prior to an actual read operation to obtain the optimum reproducing magnetic field intensity and a result of a test read bias carried out in an ideal state.

8. The storage apparatus as claimed in claim 7, further comprising:
a storing part configured to store the result of the test read bias carried out prior to the actual read operation.

9. The storage apparatus as claimed in claim 1, further comprising:
a learning part configured to update the correction value to a new correction value when a number of times the reference offset value is corrected reaches a learning threshold value by a time the reproducing magnetic field intensity actually applied to the optical recording medium reaches the optimum reproducing magnetic field intensity.

10. The storage apparatus as claimed in claim 6, wherein the correcting part corrects the reference offset value for each area on the optical recording medium.

11. A read retry method comprising:
a step increasing or decreasing a reproducing magnetic field intensity that is applied to an optical recording medium by a reference offset value; and
a correcting step correcting the reference offset value so that the reproducing magnetic field intensity that is actually applied to the optical recording medium becomes an optimum reproducing magnetic field intensity that makes a bit error rate from the optical recording medium less than or equal to a threshold value.

12. A learning method for a reproducing magnetic field control that increases or decreases a default value of a reproducing magnetic field intensity that is applied to an optical recording medium when the reproducing magnetic field intensity is increased or decreased by a reference offset value and a read of a read retry is successful, comprising:
a correcting step-correcting the reference offset value so that the reproducing magnetic field intensity that is actually applied to the optical recording medium becomes an optimum reproducing magnetic field intensity that makes a bit error rate from the optical recording medium less than or equal to a threshold value.

13. A storage apparatus comprising:
a part configured to increase or decrease a default value of a reproducing magnetic field intensity that is applied to an optical recording medium when the reproducing magnetic field intensity is increased or decreased by a reference offset value and a read of a read retry is successful; and
a correcting step correcting the reference offset value so that the reproducing magnetic field intensity that is actually applied to the optical recording medium becomes an optimum reproducing magnetic field intensity that makes a bit error rate from the optical recording medium less than or equal to a threshold value.
